(19) United States
(12) Patent Application Publication
(10) Pub. No.: US 2006/0135064 A1
(43) Pub. Date: Jun. 22, 2006

(54) Method and apparatus for bonding process in bluetooth device

(75) Inventors: Kwang-Hyun Cho, Seongnam-si (KR); Sang-Don Kim, Suwon-si (KR); Jou-Sun Baek, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/280,772

(22) Filed: Nov. 16, 2005

(30) Foreign Application Priority Data
Nov. 16, 2004 (KR) 93726/2004

(51) Int. Cl. H04B 5/00

(52) U.S. Cl. 455/41.1

(57) ABSTRACT

A method and apparatus for a bonding process in a user terminal having a Bluetooth module. The method includes recognizing a barcode of a Bluetooth device to be connected using a camera module, acquiring bonding information of the Bluetooth device from the barcode, performing pairing with the Bluetooth device using the acquired bonding information, and establishing a connection between the user terminal and the Bluetooth device after performing pairing. The bonding information may also be acquired using a secure cable in another embodiment.

### PRIORITY

This application claims priority under 35 U.S.C. § 119 to an application entitled “Method and Apparatus for Bonding Process in Bluetooth Device” filed in the Korean Intellectual Property Office on Nov. 16, 2004 and assigned Serial No. 2004-93726, the contents of which are incorporated herein by reference.

### BACKGROUND OF THE INVENTION

1. Field of the Invention

The present invention generally relates to Bluetooth communications, and in particular, to a method for a bonding process using a barcode system or a cable connection.

2. Description of the Related Art

Bluetooth is a standard for wireless communication between mobile devices such as a portable Personal Computer (PC) or a cellular phone over short distances at low costs. Bluetooth allows voice and data communications between various digital devices without a physical cable, using a radio frequency (RF) in an Industrial Scientific Medical (ISM) band of 2.45 GHz, that does not require a license for wireless communication. For example, Bluetooth wireless technology built into a cellular phone and a laptop would replace a cable used to connect the cellular phone and the laptop. Various digital devices including Personal Digital Assistants (PDA), desktops, facsimiles (FAX), keyboards, and joysticks may be included in a Bluetooth system.

FIG. 1 illustrates a general communication between Bluetooth devices.

A user terminal 100 having a Bluetooth chip establishes a wireless connection with neighboring Bluetooth devices 110 through 150 and supports a point-to-point connection and a point-to-points connection. Once the user terminal 100 requests Bluetooth device detection, information about the neighboring Bluetooth devices 110 through 150 is displayed to the user terminal 100. Then, the user terminal 100 attempts to establish a connection with a desired device among the detected Bluetooth devices 110 through 150. In this case, the user terminal 100 that requests a connection with another Bluetooth device is called a master device and a Bluetooth device to be connected is called a slave device. A master-slave relationship can be changed after establishment of the connection.

In the connection between Bluetooth devices, the security of the Bluetooth devices may become an issue. Since a user can connect to other devices anytime and perform data transmission, Bluetooth sets a security mode to solve this security problem. Bluetooth includes three security modes that can be set by a user, and each Bluetooth device operates in a single mode at a time.

A security mode 1 is a non-secure mode in which a Bluetooth device does not initiate any security procedures. In the security mode 1, security services (authentication and encryption) are completely bypassed. The security mode 1 is used when security is not required. A security mode 2 is a service-level security mode in which access to services and devices are controlled. In addition, various security policies and trust levels are defined for simultaneously running applications having different security requirements to allow access to an authorized part of the entire services. A security mode 3 is a link-level security mode in which authentication and encryption are provided based on link keys shared between Bluetooth devices.

To communicate phone data or converse in a walkie-talkie mode between Bluetooth cellular phones, a connection between the Bluetooth cellular phones is required. To connect Bluetooth devices, an authentication procedure called pairing must be performed. In other words, a Bluetooth device that desires to be connected (slave Bluetooth device) should operate in an inquiry scan or page scan mode. A Bluetooth device that attempts to make a connection (master Bluetooth device) performs an inquiry for current neighboring Bluetooth devices. Once a Bluetooth device that desires to be connected (slave Bluetooth device) is displayed on a master's screen, the master Bluetooth device selects the slave Bluetooth device and attempts to connect to the slave Bluetooth device.

In the pairing procedure, a master device shows a Personal Identification Number (PIN) code window to a user of the master device to ask a PIN code of a slave device. Once a connection is attempted after input of the PIN code, a slave device also shows a PIN code window to a user of the slave device to ask a PIN code. If the user of the slave device inputs a PIN code that is the same as that input by the user of the master device, the master device and the slave device exchange link keys assigned according to the input PIN codes, Bluetooth device addresses (BD_ADDR), and random numbers (RAND).

The link keys are provided to the master device and the slave device to be used in authentication between the master device and the slave device. The link keys are unique to a connection between the particular pair of the master device and the slave device.

Once a new connection between Bluetooth devices is established, a common link key assigned according to a PIN code is used for authentication. If an available common link key does not already exist in the Bluetooth devices, a link manager automatically performs an initialization procedure to exchange link keys.

The initialization procedure is as follows:

1. Generation of an Initialization Key

2. Generation of a Link Key

3. Link Key Exchange

4. Authentication

5. Generation of an Encryption Key in Each Unit (optional)

After the initialization procedure, the two Bluetooth devices may initiate a communication, or may terminate a connection therebetween due to an incorrect step. If encryption is requested after the communication is initiated, an E0 Secure And Fast Encryption Routine (SAFER)+algorithm is performed using an appropriate encryption key assigned according to a link key. The E0 SAFER+algorithm generates a link key of 128 bits after a PIN code is input to a Bluetooth device.

Bluetooth devices should undergo various preparatory steps and authentication for security through the foregoing conventional pairing procedure before being connected. As a result, a user should unconditionally wait without recognizing such steps. In the above steps, since messages are communicated through an Radio Frequency (RF) transmission, a message may be lost during a wireless communication. If messages are lost during RF transmission they must be repetitively transmitted to complete the conventional pairing procedure.

### SUMMARY OF THE INVENTION

It is, therefore, an object of the present invention to provide a method and apparatus, which simplifies a pairing procedure for a connection between Bluetooth devices and facilitates a user's understanding of the pairing procedure.

It is another object of the present invention to provide a method and apparatus, in which a Bluetooth device can acquire bonding information required for a connection to another Bluetooth device without undergoing steps using a wireless RF transmission.

It is still another object of the present invention to provide a method and apparatus for a bonding process, in which a Bluetooth device can acquire bonding information of another Bluetooth device to be connected by recognizing a barcode of the other Bluetooth device.

It is yet another object of the present invention to provide a method and apparatus for a bonding process, in which a Bluetooth device can acquire bonding information of another Bluetooth device to be connected through a cable.

To achieve the above and other objects, there is provided a method for a bonding process in a user terminal having a Bluetooth module. The method includes recognizing a barcode of a Bluetooth device to be connected using a camera module, acquiring bonding information of the Bluetooth device from the barcode, performing pairing with the Bluetooth device using the acquired bonding information, and establishing a connection between the user terminal and the Bluetooth device after performing pairing.

To achieve the above and other objects, there is also provided a method for a bonding process in a user terminal having a Bluetooth module. The method includes connecting to a Bluetooth device to be connected using a secure cable, acquiring Bluetooth information of the Bluetooth device and providing bonding information of the user terminal through the secure cable, performing pairing with the Bluetooth device using the acquired bonding information, and establishing a connection between the user terminal and the Bluetooth device after performing pairing.

To achieve the above and other objects, there is also provided an apparatus for a bonding process in a user terminal having a Bluetooth module. The apparatus includes a controller for recognizing a request for a connection to a Bluetooth device to be connected using a barcode system from a user, a camera module for sensing a barcode of the Bluetooth device under the control of the controller, a barcode recognizing unit for analyzing the barcode sensed by the camera module and acquiring bonding information of the Bluetooth device, and a Bluetooth module for performing pairing with the Bluetooth device using the acquired bonding information.

To achieve the above and other objects, there is also provided an apparatus for a bonding process in a user terminal having a Bluetooth module. The apparatus includes a controller for recognizing a request for a connection to a Bluetooth device to be connected using a secure cable from a user, a cable connection unit for recognizing the secure cable connected to the Bluetooth device under the control of the controller, acquiring bonding information of the Bluetooth device through the secure cable, and providing bonding information of the user terminal, and a Bluetooth module for performing pairing with the Bluetooth device using the acquired bonding information of the Bluetooth device.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates a general communication between Bluetooth devices;

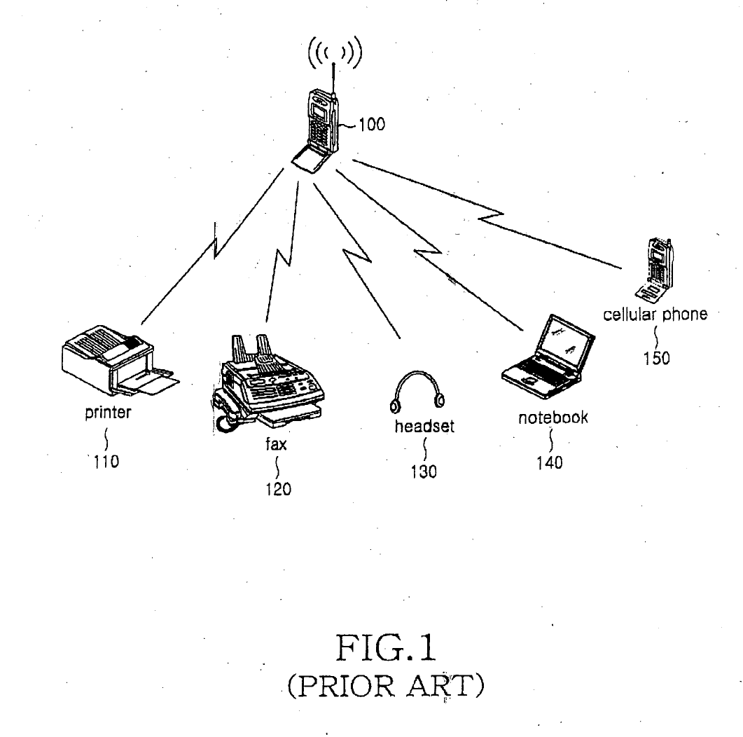

FIG. 2 is a block diagram of a user terminal according to a first embodiment of the present invention;

FIG. 3 illustrates a bonding process in a Bluetooth device using a barcode system according to a first embodiment of the present invention;

FIG. 4 is a block diagram of a user terminal according to a second embodiment of the present invention; and

FIG. 5 illustrates a bonding process in a user terminal according to a second embodiment of the present invention.

### DETAILED DESCRIPTION OF THE PREFERRED EMBODIMENT

Preferred embodiments of the present invention will now be described in detail with reference to the annexed drawings. In the following description, a detailed description of known functions and configurations incorporated herein has been omitted for conciseness.

The main object of the present invention is to acquire bonding information of a Bluetooth device to be connected without a wireless procedure during authentication between Bluetooth devices. In other words, a bonding process is performed using a barcode or a cable without a modification to a conventional standard for Bluetooth. Hereinafter, a description will be made regarding embodiments of the present invention for receiving bonding information.

In the first embodiment of the present invention, a Bluetooth user terminal recognizes another Bluetooth device using a mobile barcode system. The first embodiment is implemented by a Bluetooth device having a camera module 220 and a barcode recognizing unit 230 as shown in the block diagram of a user terminal according to the first embodiment of the present invention.

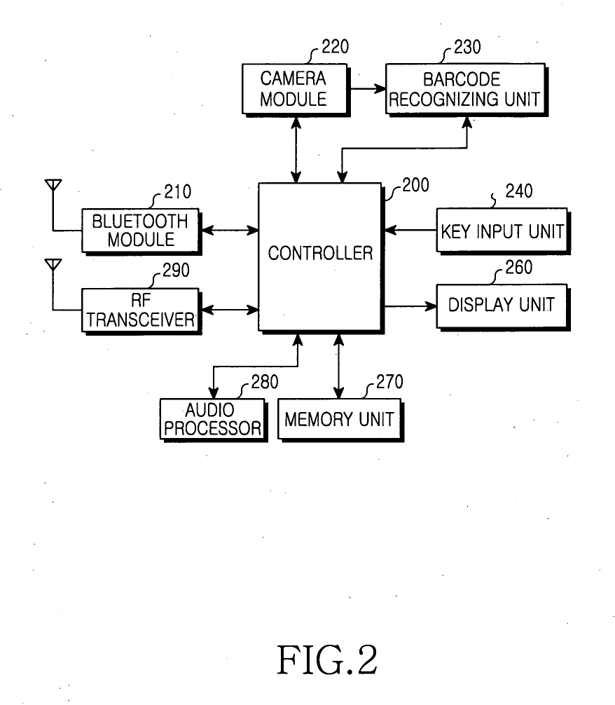

Referring to FIG. 2, a controller 200 controls the overall operation of a mobile communication terminal. A memory unit 270 stores a predetermined program for controlling the overall operation of the mobile communication terminal and stores data input and output when the overall operation of the mobile communication terminal is performed and data is transmitted from an image service system center in a predetermined memory area.

A camera module 220 converts an image or a moving picture to a digital form, and the controller 220 stores the digital form in the memory unit 270. A barcode recognizing unit 230 for reading a barcode recognizes a barcode using the camera module 220, and the controller 220 stores read barcode information in the memory unit 270.

A key input unit 240 includes a plurality of number keys and function keys. Once a user presses a predetermined key, the key input unit 240 generates corresponding key data and outputs the key data to the controller 200. A display unit 260 includes a Liquid Crystal Display (LCD) (not shown) for displaying various information, is controlled by the controller 200, receives the key data from the key input unit 240 and various information signals from the controller 200, and displays received data. A radio frequency (RF) transceiver 290 performs a wireless communication with a base station (not shown) and amplifies and filters transmitted and received signals to allow an RF signal to be exchanged between the controller 200 and the base station (not shown).

A Bluetooth module 210 performs wireless communications with other Bluetooth devices and allows an RF signal to be exchanged between the controller 200 and other Bluetooth devices. In particular, the Bluetooth module 210 broadcasts a request message for a connection with a Bluetooth device corresponding to the read barcode information. An audio processor 280 modulates an audio signal input from a microphone to convert the modulated audio signal into an RF signal under the control of the controller 200 and outputs the audio signal to a speaker when a ring signal is generated from the base station or during a connection or a termination of a connection between Bluetooth devices.

When a Bluetooth terminal having the camera module 220 mounted therein desires to connect to a Bluetooth device having a barcode, it recognizes the barcode of the Bluetooth device using the camera module 220, acquires bonding information including a BD_ADDR of the Bluetooth device and other information required for a connection from the barcode, and automatically performs an initial operation.

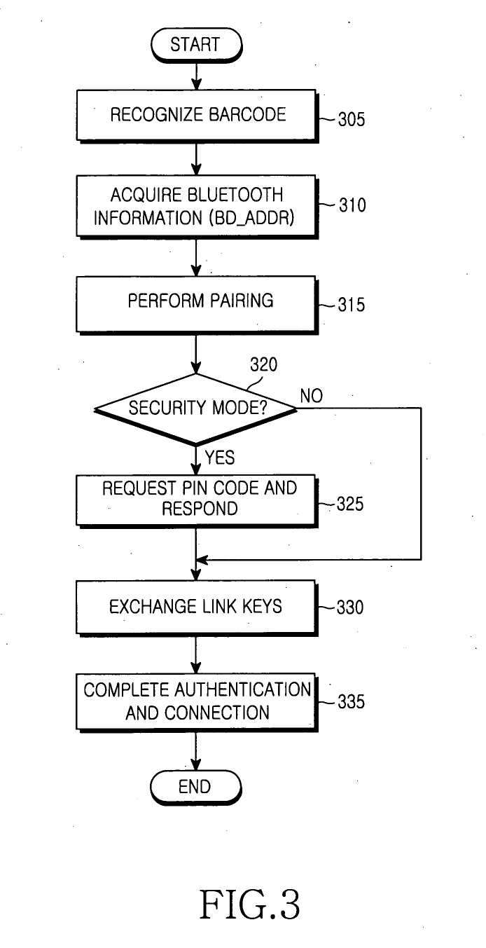

FIG. 3 illustrates a bonding process in a Bluetooth device using a barcode system according to the first embodiment of the present invention.

For example, once a user selects a ‘Connection using barcode’ item in a ‘Bluetooth’ menu displayed on a screen of the Bluetooth device, a user terminal outputs a ‘Course of recognizing Bluetooth barcode’ message and recognizes a barcode of a Bluetooth device to be connected using a camera in step 305. At this time, the Bluetooth device whose screen displays the ‘Course of recognizing Bluetooth barcode’ message is a master device, and the Bluetooth device to be connected is a slave device. The slave device should be in a pairable mode. The barcode may be output on a display window of the slave device or attached or imprinted on the exterior of the slave device. Alternatively, the barcode may be acquired from a separate medium. The master device analyzes the barcode to acquire BD_ADDR information about the slave device in step 310 and performs pairing in step 315.

If the master device is in a security mode in step 320, it requests a PIN code from the slave device in step 325 and performs authentication with respect to the slave device. Similarly, if the slave device is in the security mode, it receives a request for a PIN code from the master device and responds to the request with a user-input PIN code.

If link keys are exchanged for encryption in step 330 and a connection is normally completed, a user terminal outputs a beep sound to inform a user of the completion of the connection in step 335 and maintains the connection until the user inputs a connection release command. However, if the master device is not in the security mode in step 320, a process goes to step 330 to exchange link keys. Authentication and a connection are then completed in step 335. At this time, the master device outputs a beep sound to inform the user of the completion of the connection.

In the second embodiment of the present invention, authentication between Bluetooth devices is performed using a secure cable.

For example, if the Bluetooth device to be connected to a cellular phone, an interface cable for connecting the two devices is used to exchange BD_ADDR between the two devices. The interface cable has a pin structure that is the same as an existing interface cable and has the same pin structure at both its ends in which Universal Asynchronous Receiver/Transmitters (UARTs) interface with each other to exchange data. The interface cable includes a UART receiver (Rx), a UART transmitter (Tx), and a ground line. In another embodiment of the present invention, various cable communication standards can be adopted. In the present invention, the interface cable will be referred to as a secure cable.

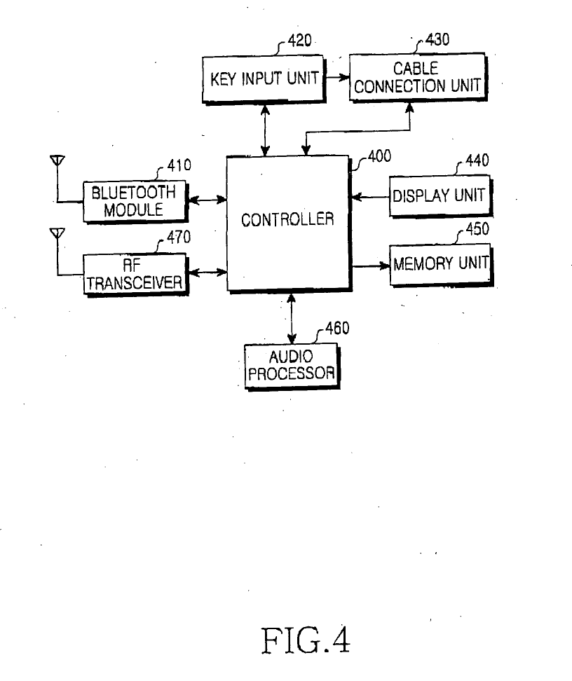

FIG. 4 is a block diagram of a user terminal according to a second embodiment of the present invention.

Referring to FIG. 4, a controller 400 controls the overall operation of a mobile communication terminal. A memory unit 450 stores a predetermined program for controlling the overall operation of the mobile communication terminal and stores data input and output when the overall operation of the mobile communication terminal is performed by the controller 400 and data is transmitted from an image service system center in a predetermined set area.

A key input unit 420 includes a plurality of number keys and function keys. Once a user presses a predetermined key, the key input unit 420 generates corresponding key data and outputs the key data to the controller 400. A display unit 440 includes a Liquid Crystal Display (LCD) (not Shown) for displaying various information, is controlled by the controller 400, receives the key data from the key input unit 420 and various information signals from the controller 400, and displays the received data. A cable connection unit 430 generically represents a cable input/output unit for connecting to or charging a computer or a Bluetooth device. When a secure cable is connected or the connection is terminated the cable connection unit 430 informs a user with a beep sound output from the audio processor 460 or a message displayed on the LCD of the display unit 440 under the control of the controller 400.

An RF transceiver 470 performs a wireless communication with a base station (not shown) and amplifies and filters transmitted and received signals to allow an RF signal to be exchanged between the controller 400 and the base station (not shown).

A Bluetooth module 410 performs wireless communications with other Bluetooth devices and allows an RF signal to be exchanged between the controller 400 and other Bluetooth devices.

An audio processor 460 modulates an audio signal input from a microphone to convert the modulated audio signal into an RF signal under the control of the controller 400 and outputs the audio signal to a speaker when a ring signal is generated from the base station or during a connection or a termination of a connection between Bluetooth devices.

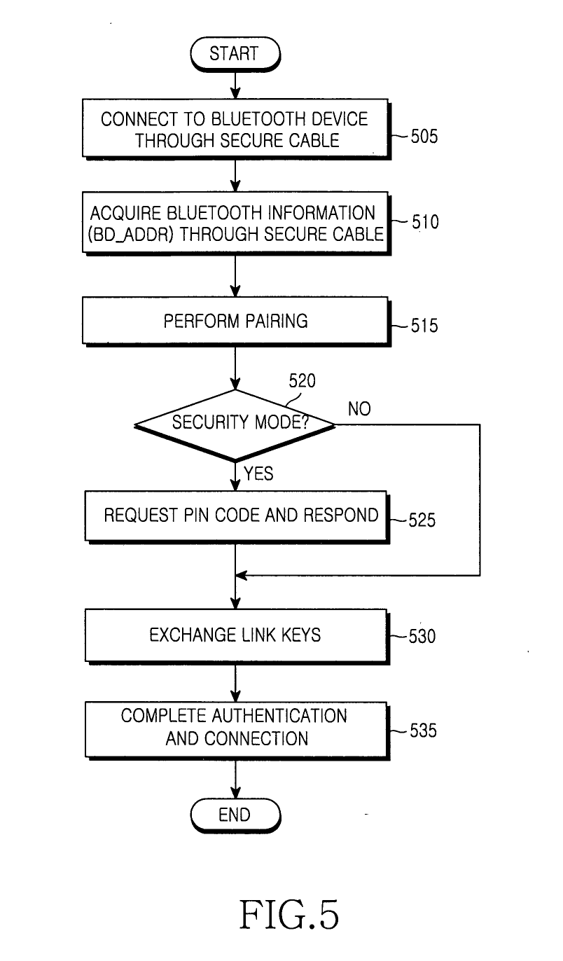

FIG. 5 illustrates a bonding process in a user terminal according to a second embodiment of the present invention.

In step 505, a user terminal connects to an interface connector of a Bluetooth device through a secure cable. At this time, the user terminal is a master device and the Bluetooth device is a slave device. The slave device should be in a pairable mode. After the connection to the interface connector is sensed, the user terminal provides its Bluetooth information including BD_ADDR to the Bluetooth device through the secure cable using a predetermined format command, e.g., an AT command (that is a representative protocol used in serial communication) in step 510. The user terminal receives BD_ADDR from the Bluetooth device to perform pairing in step 515. If the user terminal is in a security mode in step 520, it requests a PIN code from the Bluetooth device in step 525 and performs authentication with respect to the Bluetooth device. Similarly, if the Bluetooth device is in the security mode, the user terminal receives a request for a PIN code from the Bluetooth device and responds the request with a user-input PIN code.

Once link keys are exchanged for authentication in step 530 and a connection is completed normally in step 535, the user terminal outputs a beep sound to inform the user of the completion of the connection and maintains a Bluetooth connection until the user inputs a connection release command. However, if the user terminal is not in the security mode in step 520, the process proceeds to step 530 to exchange link keys generated using an authentication algorithm through the secure cable. After the link keys are exchanged, authentication and a connection are completed in step 535. At this time, the user terminal outputs a beep sound to inform the user of the completion of the connection.

As described above, according to the present invention, bonding information of a Bluetooth device is acquired by reading a barcode of the Bluetooth device using a camera or through a cable connection between Bluetooth devices. Thus, a user can easily perform and understand a bonding process and the security of the Bluetooth devices can be ensured.

While the invention has been shown and described with reference to certain preferred embodiments thereof, it will be understood by those skilled in the art that various changes in form and details may be made therein without departing from the spirit and scope of the invention.

What is claimed is:

1. A method for a bonding process in a user terminal having a Bluetooth module, the method comprising the steps of:
recognizing a barcode of a Bluetooth device to be connected using a camera module;
acquiring bonding information of the Bluetooth device from the barcode;
performing pairing with the Bluetooth device using the acquired bonding information; and
establishing a connection between the user terminal and the Bluetooth device after performing pairing.

2. The method of claim 1, wherein the bonding information includes an address of the Bluetooth device.

3. The method of claim 1, wherein the step of performing pairing comprises the steps of:
requesting a Personal Identification Number (PIN) code from the Bluetooth device and receiving a user-input PIN code from the Bluetooth device, if the user terminal is in a security mode; and
determining that authentication is successful if the received PIN code is correct if the user terminal is in the security mode, and link keys are exchanged with the Bluetooth device.

4. The method of claim 3, wherein the link keys are a common link key assigned according to the PIN code.

5. A method for a bonding process in a user terminal having a Bluetooth module, the method comprising the steps of:
connecting to a Bluetooth device using a secure cable;
acquiring Bluetooth information of the Bluetooth device and providing bonding information of the user terminal through the secure cable;
performing pairing with the Bluetooth device using the acquired bonding information; and
establishing a connection between the user terminal and the Bluetooth device after performing pairing.

6. The method of claim 5, wherein the bonding information includes an address of the Bluetooth device.

7. The method of claim 5, wherein the step of performing pairing comprises the steps of:
requesting a Personal Identification Number (PIN) code from the Bluetooth device and receiving a user-input PIN code from the Bluetooth device, if the user terminal is in a security mode;
determining that authentication is successful if the received PIN code is correct if the user terminal is in the security mode, and link keys are exchanged with the Bluetooth device.

8. The method of claim 7, wherein the link keys are a common link key assigned according to the PIN code and are exchanged through the secure cable.

9. An apparatus for a bonding process in a user terminal having a Bluetooth module, the apparatus comprising:
a controller for recognizing a request from a user for a connection to a Bluetooth device using a barcode system;
a camera module for sensing a barcode of the Bluetooth device under the control of the controller;
a barcode recognizing unit for analyzing the barcode sensed by the camera module and acquiring bonding information of the Bluetooth device; and
the Bluetooth module for performing pairing with the Bluetooth device using the acquired bonding information of the Bluetooth device.

10. An apparatus for a bonding process in a user terminal having a Bluetooth module, the apparatus comprising:
a controller for recognizing a request from a user for a connection to a Bluetooth device using a secure cable;
a cable connection unit for recognizing the secure cable connected to the Bluetooth device under the control of the controller, acquiring bonding information of the Bluetooth device through the secure cable, and providing bonding information of the user terminal; and
the Bluetooth module for performing pairing with the Bluetooth device using the acquired bonding information.

11. The apparatus of claim 10, wherein the secure cable includes a Universal Asynchronous Receiver/Transmitter (UART) receiver, a UART transmitter, and a ground line.
